(19) United States
(12) Patent Application Publication
(10) Pub. No.: US 2006/0019217 A1
(43) Pub. Date: Jan. 26, 2006

(54) Anterior composite matrix dental restoration system

(76) Inventor: David W. Yates, Palm City, FL (US)

Correspondence Address: Richard C. Litman;LITMAN LAW OFFICES, LTD., P.O. Box 15035, Arlington, VA, 22215, US

(21) Appl. No.: 10/896,005

(22) Filed: Jul. 22, 2004

(51) Int. Cl. A61C 5/04; A61C 3/14

(52) U.S. Cl. 433/155; 433/39; 433/159

(57) ABSTRACT

The anterior composite matrix dental restoration system provides a matrix for holding a composite filling material in place as it cures, and a tool for holding the matrix in place during the curing of the filling material. The matrix comprises a thin, flat, flexible, and transparent sheet of plastic material with parallel tubular extensions on the opposite ends. The distal ends of the specialized forceps tool are inserted into the tubular ends of the matrix and used to install, hold, and remove the matrix. The relatively small and narrow tool greatly increases the comfort of both patient and dentist or dental technician by precluding need to insert and hold the fingers in the mouth of the patient to install, hold, and remove the matrix. The matrices may be provided in different sizes, with at least the tubular end components being optionally color coded to indicate the corresponding size.

### BACKGROUND OF THE INVENTION

1. Field of the Invention

The present invention relates generally to dental tools and equipment, and more specifically to a small matrix or dam which is placed about an anterior tooth to hold the composite filling material in place during the curing process. The matrix includes fittings on each end thereof adapted for engagement by a tool for installing and removing the matrix, the installation and removal tool in combination with the matrix forming the system.

2. Description of the Related Art

Dental work and repair is perhaps the most commonly required and performed medical procedure in the United States. The majority of such work, other than periodic checkups and cleaning, is the repair or filling of dental caries. The process is delicate and exacting, to insure that the filling material is properly placed and shaped to avoid discomfort or future problems for the patient.

Decay most often occurs in more difficult areas to clean, e.g., along the gum line and between teeth. Various classifications of cavities and tooth repair have been developed according to the area of the tooth where the problem occurs. Class III cavities and fillings, i.e., those which occur between teeth, are perhaps the most difficult to treat due to the immediate proximity of the adjacent tooth.

Accordingly, various devices and aids have been developed to assist the dentist in working in this area. For example, protective devices formed of a thin, hard metal are applied between the damaged tooth and adjacent tooth to protect the adjacent tooth from damage during the drilling process, for decay removal. Additional devices formed of thin, flexible plastic strips have been developed for placement between the teeth, to act as a dam or matrix to hold the composite filling material in place during the curing process.

These devices may be divided into two general types, according to their principle of operation. In one case, adhesives have been applied to the matrices to hold them in place, but the adhesives have often been found ineffective in the oral environment, and when they do work, often result in pulling the freshly applied filling composite from the tooth when the dam is removed. Other, non-adhesive strips have been developed, but these require the dentist or technician to hold the strip in place manually up to several minutes while the filling material cures. This is clearly uncomfortable for both the patient and the dentist or technician.

The present invention provides a solution to this problem by means of a thin, flexible strip of plastic material which serves as a matrix or dam during the curing process for an anterior tooth, class III filling. The present matrix is formed of a flexible, transparent or translucent strip of plastic material and includes a transverse, generally cylindrical passage at each end thereof. An installation, holding, and removal tool is provided, with the tool configured as a small forceps having distal ends for inserting into the passages of the matrix strip. A dentist or dental technician may easily install the matrix and hold it in place by means of the matrix forceps tool without needing to hold his or her fingers in the mouth of the patient during the time the composite filling is curing, thus greatly improving the comfort of both the dental patient and the dentist or technician.

A discussion of the related art of which the present inventor is aware, and its differences and distinctions from the present invention, is provided below.

U.S. Pat. No. 2,647,315 issued on Aug. 4, 1953 to Lewis H. Dvorak, titled “Dental Matrix Instrument,” describes a complex mechanical tool for securing a matrix band between two adjacent teeth (not partially around a single tooth, as in the present invention). The device includes a band which is wedged between the teeth to bear against the sides of the adjacent teeth, with a retaining spreader disposed along the back of the band, opposite the adjusting mechanism. Each end of the band is gripped by an oppositely threaded component, with a rod having opposite direction threads engaging the two band gripping components. Turning the rod in one direction spreads the threaded components apart, thereby pulling the ends of the matrix band apart and increasing the pressure of the band against the sides of the adjacent teeth to hold a filling material in place. Rotating the rod in the opposite direction allows the ends of the band to approach each other, thereby loosening the band between the teeth for removal thereof. In contrast, the present dental matrix band partially encircles a single tooth and does not apply a wedging pressure between two adjacent teeth, as does the Dvorak device. Moreover, the Dvorak assembly is formed of metal, according to the description of various components throughout his disclosure. The band itself which passes between the teeth is also formed of metal, as is clear from the description of soldering another component to the band in a modification of the device (col. 7, lines 53-55). The present dental matrix is formed of a thin, transparent or translucent plastic material to allow the passage of ultraviolet light therethrough, for curing or hardening filling materials which are set by exposure to ultraviolet light. Moreover, the present dental matrix and tool utilizes a small forceps type tool for the installation, holding, and removal of the matrix band, rather than a threaded turnbuckle type tool as in the Dvorak device.

U.S. Pat. No. 3,482,314 issued on Dec. 9, 1969 to Benjamin F. Tofflemire, titled “Closed-Loop Dental Matrix Band With Combined Keeper And Traction Block,” describes a band and tool in which the band is wrapped about the tooth. The ends of the band are brought together and a retaining clamp is passed over the ends of the band and moved toward the tooth. A keeper or clip is then permanently attached (riveted or pinned) to the ends of the band, and a tool is applied to the assembly to slide the retaining clamp along the band toward the tooth and away from the clip affixed to the band, thereby tightening the band around the tooth. As the Tofflemire band must remain thin and flat to allow the retaining clamp and keeper to be installed thereover, Tofflemire cannot include any cylindrical ends on his band. Thus, the Tofflemire band cannot be used with the forceps tool of the present invention, which engages the opposed tubular sleeves on the opposite ends of the present band.

U.S. Pat. No. 4,824,365 issued on Apr. 25, 1989 to Hans von Weissenfluh, titled “Dental Matrix In A Flexible Strip With Tightener Connected To It,” describes an assembly much like that of the Tofflemire device described immediately above. The von Weissenfluh device comprises a flexible band which is wrapped around the tooth, with a generally circular retainer being secured to the paired free ends of the band. The free ends of the band pass through a slot in one side of the circular retainer, and are permanently affixed to the opposite side of the circle. Compressing the sides of the circle elongates the retainer, thereby urging the slotted side toward the tooth and drawing the band taut around the tooth. Von Weissenfluh provides opposed retaining ridges extending from the band at the gingival and occlusal ends of the tooth, but these ridges differ from the forceps passages of the present band in that (1) they are not hollow to allow the passage of the tip of a tool therein, and (2) they are disposed at the opposite edges of the band, rather than at the opposite ends, as in the present matrix band.

U.S. Pat. No. 5,382,160 issued on Jan. 17, 1995 to Arthur Shemet, titled “Dental Matrix With Retention And Locking Mechanism,” describes a flexible, translucent plastic band having a slot at each end thereof and a mechanically toothed extension extending from each end adjacent the slot. The device is wrapped around the tooth and the opposite extensions are passed through the opposing slots, with the mechanical teeth of the device engaging the edges of the slots to secure the device in place. The finite number of mechanical teeth result in only a relatively few, finite positions and tensile forces which may be applied using the Shemet matrix. In contrast, the present matrix depends upon the dentist or dental technician to apply virtually infinitesimally variable force to the device to adjust the pressure precisely as required. Moreover, the tool used to apply the tensile pressure with the present dental matrix is also used to install and remove the matrix. The Shemet matrix must be cut away after use.

U.S. Pat. No. 5,425,635 issued on Jun. 20, 1995 to Theodore P. Croll, titled “Matrix Band Segment And Restoration Procedure,” describes a thin, blade-like matrix segment formed of stainless steel (col. 2, line 36). The device cannot encircle a substantial portion of a tooth, as provided by the present dental matrix invention, and thus cannot apply radially inward pressure to hold a composite filling material in place during the curing or hardening thereof. Moreover, the Croll matrix is opaque due to its metal construction, and cannot pass ultraviolet light therethrough to provide curing of composite materials which set or cure by exposure to such ultraviolet light.

U.S. Pat. No. 6,234,793 issued on May 22, 2001 to Steven J. Brattesani et al., titled “Textured Dental Matrix Bands And Related Methods,” describes a dental matrix having a smooth surface which is applied to the tooth, and an opposite roughened surface against which a wedge may be applied between the teeth to hold the matrix in place. A relatively complex matrix installation tool is also disclosed. The matrix material may be provided either as separate, single-use units, or as a continuous strip to be dispensed from the tool or from a roll. Neither embodiment includes any tubular end passages for gripping by the distal ends of a forceps tool, as provided by the present invention.

U.S. Pat. No. 6,350,122 issued on Feb. 26, 2002 to Alvin Meyer, titled “Dental Matrix With Lateral Illumination Ports,” describes a relatively short matrix segment configured to pass about one side of the tooth. The Meyer matrix is formed of thin metal shim material (col. 3, lines 29-30) and accordingly requires passages therethrough to allow ultraviolet light to pass through the device in order to cure the underlying composite restoration material. The present matrix differs considerably, in that it is formed of a translucent or transparent plastic material which allows the passage of ultraviolet light therethrough.

U.S. Pat. No. 6,471,516 issued on Oct. 29, 2002 to John T. Nilsson, titled “Means For Inserting Filling Material During Dental Treatment,” describes a tool having a specific shape for compacting restorative filling material in a cavity. Only a very generic matrix is shown in edge view in one of the drawing figures, and that matrix does not bear closely against a substantial portion of the tooth, as does the present dental matrix invention.

U.S. patent Publication No. 2003/148,245 published on Aug. 7, 2003, titled “Dental Implement For Tooth Restorations,” describes a ring formed of a flattened spring wire, with one side of the ring being open and terminating in a pair of depending jaws. The device is used to clamp relatively short dental matrix segments in place along one side of a tooth.

U.S. Design Pat. No. 375,361, issued on Nov. 5, 1996 to Ole Østerby et al., titled “Proxitector,” illustrates a design for a device marketed as “Interguard,” a disclosure of which was available on the Internet as of Apr. 23, 2004 at the website at www.interguard.dk. The Internet disclosure also shows an e-mail address including the first inventor's name for the '361 U.S. Design Pat. The Interguard device of the '361 U.S. Design Pat. and of the website noted above, is formed of stainless steel, and is configured to protect an adjacent tooth from inadvertent damage during drilling and similar operations. The Interguard device of the '361 U.S. Design Pat. is thus relatively inflexible and opaque, and cannot pass ultraviolet light therethrough to cure restorative filling material, as can the present matrix. The only tool disclosed for use with the Interguard device is a length of dental floss or the like, which is passed through a hole in the device to provide for removal. No forceps or other installation tool is disclosed, and the only means for holding the device in place is by the tight fit between adjacent teeth. The inflexibility of the device precludes any ability to wrap at least partially around a tooth to provide a dam for the restorative filling material used to fill a cavity, as provided by the present matrix invention.

International Patent No. WO 84/1100, published on Mar. 29, 1984, titled “Improved Dental Matrix Band,” describes a device closely resembling the matrix installation tool of the Dvorak '315 U.S. Pat., discussed further above. The '1100 device includes a metal flap attachment inboard of the band, with the space between the flap and band providing for a wedge to be driven therebetween to provide a tighter fit. The installation tool is described in the '1100 patent as a “conventional Tofflemire—type retaining appliance” (page 8, lines 32-33) apparently referring to the appliance in the Tofflemire '314 U.S. Pat. discussed further above. The completely encircling metal band of the '1100 device cannot pass ultraviolet light therethrough for curing dental restorative material, as provided by the present transparent or translucent matrix. Moreover, the installation tool is relatively complex in comparison to the forceps provided with the present invention.

Finally, German Patent Publication No. 3,907,338, published on Feb. 1, 1990, titled “Matrix Fixator For Dental Purposes,” describes (according to the drawings and English abstract) a tool closely resembling the Tofflemire matrix tool of the '1100 International patent discussed immediately above. The device includes a threaded rod which is tightened to secure the matrix completely about the tooth in a loop. Accordingly, the matrix band does not include any form of end passages or cylinders for the insertion of the distal ends of a forceps tool therein, as provided by the present invention.

None of the above inventions and patents, taken either singly or in combination, is seen to describe the instant invention as claimed. Thus, an anterior composite matrix dental restoration system solving the aforementioned problems is desired.

### SUMMARY OF THE INVENTION

The present anterior composite matrix dental restoration system essentially comprises a relatively short, small, thin, flexible, and transparent strip of plastic material which is removably inserted between adjacent teeth to hold composite dental filling material in place in a class III dental restoration as it cures. The system may further include a tool for installing and manipulating the strip during the restoration process. The matrix strip includes a tubular extension at each end, into which the distal ends of the specialized tool may be inserted to install and remove the plastic matrix and to hold it in place as the composite material cures. The matrix may be formed in various widths and sizes as required, with the ends being optionally color-coded for identification of the size. The transparent nature of the material allows ultraviolet light to pass therethrough in order to cure ultraviolet sensitive composite filling material contained therein.

The dentist using the present system need only place the matrix in position to partially encircle the tooth and cover the filling material, and then hold the matrix dam in place by means of the special forceps tool as the filling material cures. The relatively small forceps tool provides considerably greater comfort for both the patient and the dentist or technician by precluding the need to hold one's fingers within the mouth of the patient as the composite filling material cures. The same tool used for installation of the matrix, for holding the matrix in place during the curing of the filling material, for removing the matrix after the filling material has cured.

These and other features of the present invention will become readily apparent upon consideration of the following specification and drawings.

### BRIEF DESCRIPTION OF THE DRAWINGS

FIG. 1 is an environmental, perspective view of an anterior composite matrix dental restoration system according to the present invention, showing the installation of a matrix using the forceps tool of the present invention.

FIG. 2 is an enlarged, environmental rear elevation view showing the completed placement and holding of two matrices using the forceps of the present invention.

FIG. 3 is an enlarged, environmental top plan view showing the placement of a single matrix between two adjacent teeth.

FIG. 4 is a greatly enlarged side elevation view showing details of the matrix and forceps tool for use therewith.

FIG. 5 is a greatly enlarged side elevation view showing the matrix in section with the forceps tool installed therein.

FIG. 6 is a greatly enlarged top plan view showing further details of the dental matrix.

FIG. 7 is a rear elevation view of a series of matrices having different heights, showing exemplary color codes to indicate their respective heights.

Similar reference characters denote corresponding features consistently throughout the attached drawings.

### DETAILED DESCRIPTION OF THE PREFERRED EMBODIMENTS

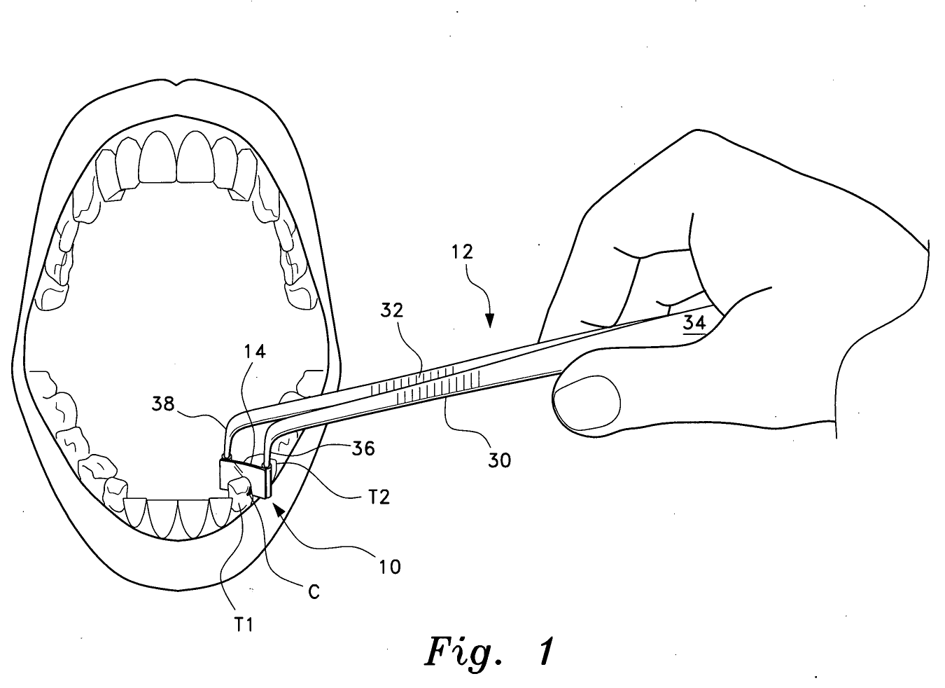

The present invention comprises various embodiments of an anterior composite matrix dental restoration system, i.e., a dental matrix and a manipulation tool therefor, for use in holding a filling material in place in a front (anterior) tooth as the filling material sets or cures in the previously prepared tooth. FIG. 1 of the drawings provides an illustration showing an exemplary installation of the present matrix 10 between two adjacent anterior teeth T1 and T2, with the forwardmost tooth T1 having a freshly prepared cavity C therein. Dental caries, such as the cavity C, often form between teeth due to trapped food lodging between the teeth that supports decay-causing bacteria. These between-the-teeth cavities are classified as class III, when they extend along the side of a tooth, although they may approach the front and back of the tooth as well, or more technically, cavities in the proximal surfaces of incisors and cuspids or canines not requiring removal of the incisal angle. The present anterior composite dental matrix restoration system is particularly well suited for use in the repair of such class III cavities.

The present anterior composite matrix 10 is configured for use in treating and repairing such damage by placing the matrix between the affected tooth T1 and the adjacent tooth T2, where the matrix 10 acts as a dam to hold the filling material in place as it sets or cures. The matrix 10 is configured for use with a specially configured pair of forceps 12, which positively grip the matrix 10 for installation, for holding the matrix in place, and for removing the matrix from between two adjacent teeth.

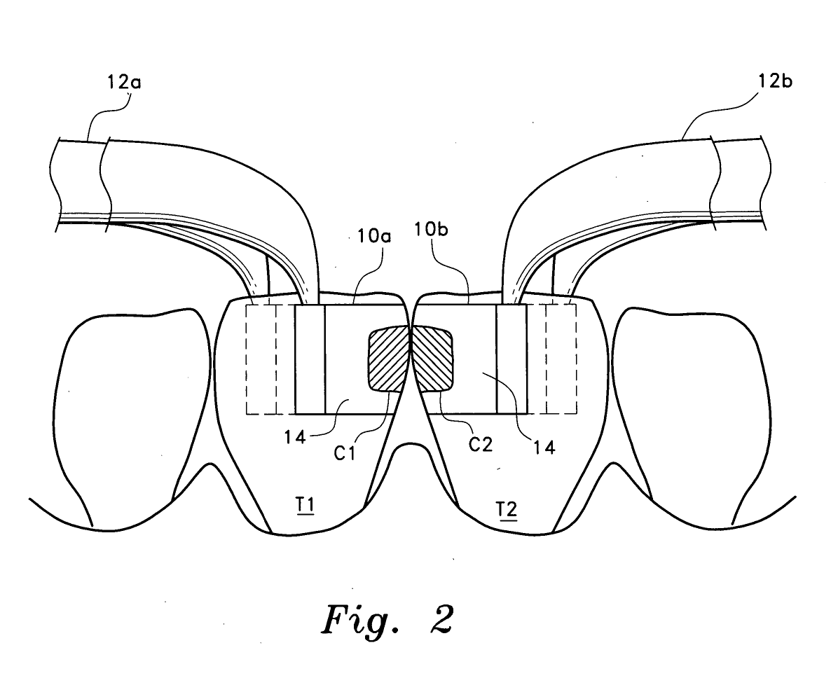

FIG. 2 provides a more detailed front elevation view showing the placement of two matrices 10a and 10b between a pair of adjacent anterior teeth T1 and T2 having cavities C1 and C2 therein, with the two matrices 10a and 10b being held in place by forceps pairs 12a and 12b. It will be understood that normally only a single matrix would be placed between two teeth to hold the filling material in place as it sets in a cavity, e.g., cavity C1, with an adjacent cavity C2 being treated and filled in sequence. However, FIG. 2 is intended to illustrate the versatility of the matrix 10 by showing its ability to be curved about the exterior of a tooth in either a left or right concave curvature.

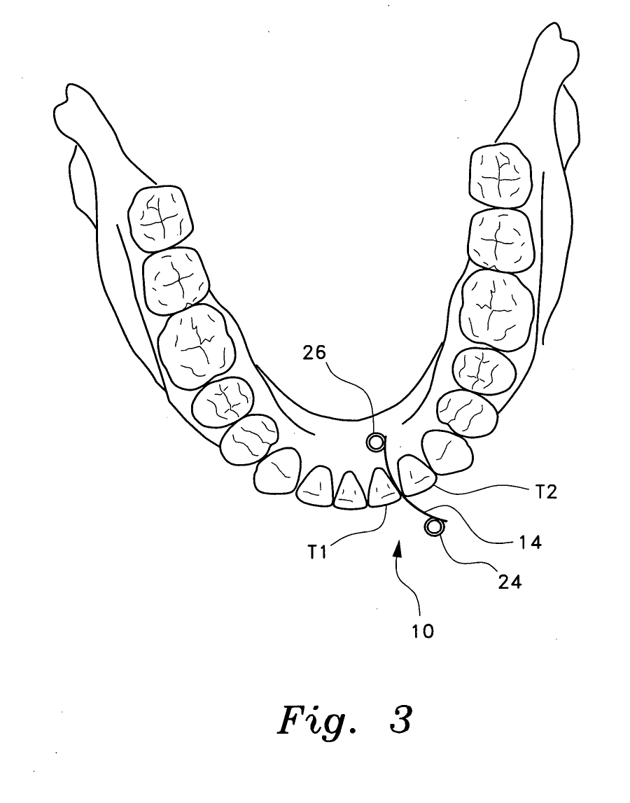

FIG. 3 provides a top plan view of the initial placement of a matrix 10 between adjacent teeth T1 and T2, showing a matrix installation similar to that of the perspective view shown in FIG. 1. The forceps 12 are not shown in FIG. 3 for clarity in the drawing figure. The matrix 10 (or 10a, 10b, etc.) essentially comprises a thin, flexible, continuous and unbroken, translucent, generally rectangular matrix sheet of plastic material 14. The plastic matrix sheet 14 may be formed of any suitable plastic material, e.g., polyester, polyethylene, and other synthetic polymer plastics, including Mylar® (Mylar is a registered trademark of E.I. du Pont de Nemours & Co. for a polyester film) and other trade name plastics having suitable characteristics.

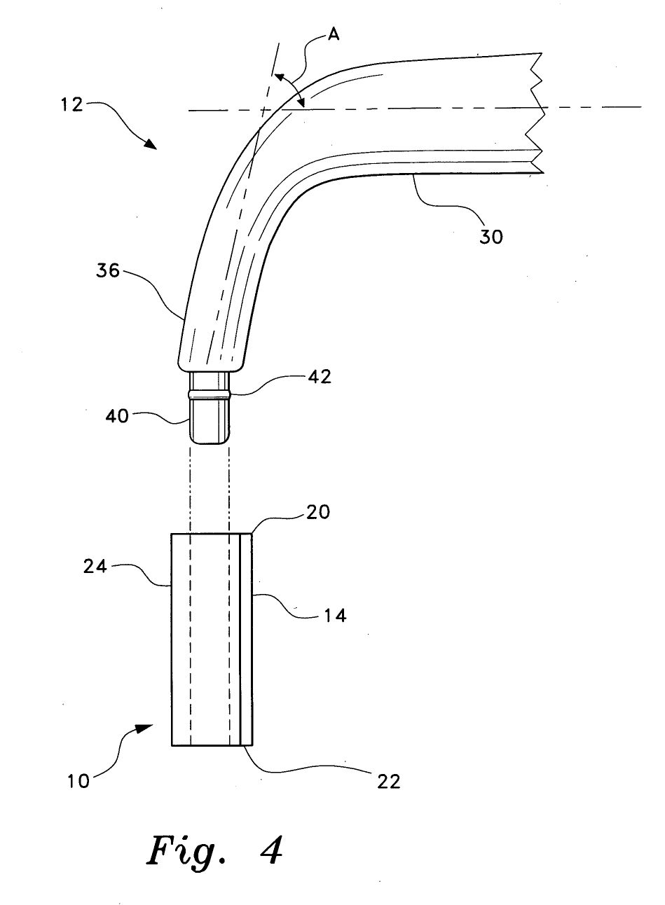

As shown in FIGS. 4-6, the matrix sheet 14 is defined by a first end 16, a second end 18 opposite the first end, a first edge 20, and a second edge 22 opposite the first edge. The plastic matrix sheet 14 is preferably relatively thin, in order to pass between two adjacent teeth which may be in contact with one another. A thickness of only about 0.05 mm, or approximately 0.002 in., is quite suitable for such service and provides sufficient strength depending upon the specific type of plastic material used.

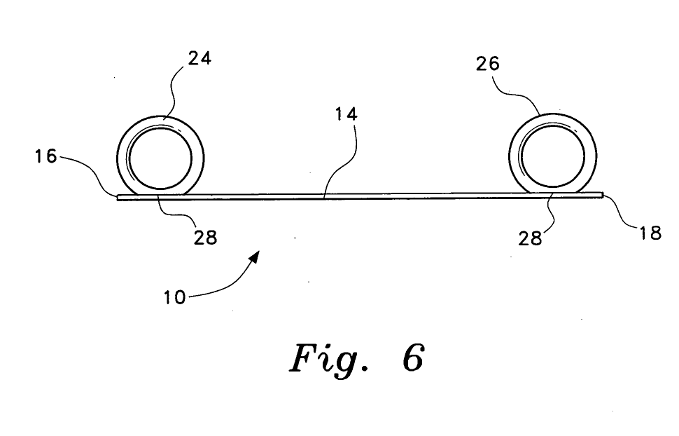

The first and second ends 16 and 18 of the matrix sheet 14 respectively have a hollow first and second matrix tube 24 and 26 attached thereto. The two tubes 24 and 26 are substantially parallel to one another, and are attached to the respective matrix sheet ends 16 and 18 by any suitable means, e.g., adhesive bonding, fusion, etc. as desired. Each of the tubes 24 and 26 has a flattened matrix sheet attachment surface or side 28, as shown most clearly in FIG. 6, to provide a relatively large area for bonding or fusing to the flat portion of the matrix sheet 14 adjacent the ends 16 and 18 thereof. The tubes 24 and 26 are preferably formed of nylon to provide the desired flexibility and strength, but other suitable plastics may be used as desired.

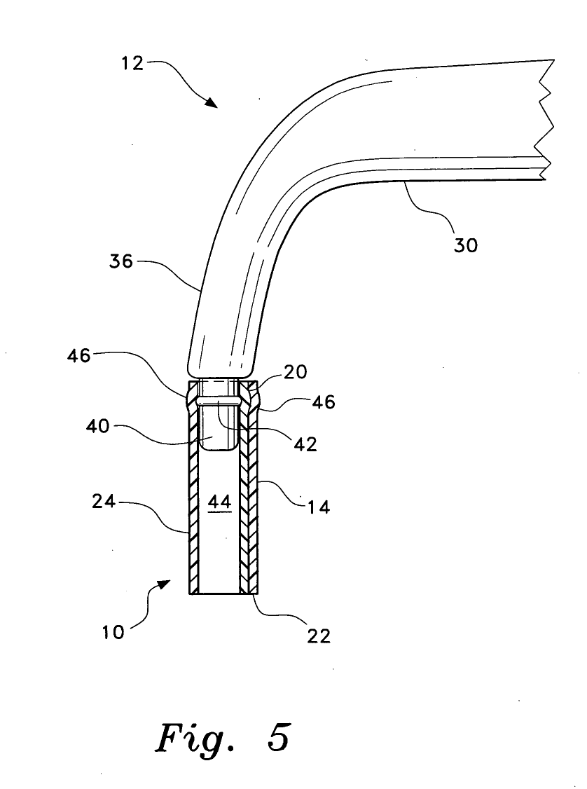

FIGS. 4 and 5 illustrate the grasping of the matrix 10 using the forceps tool 12 of the present invention. The forceps pair 12 includes first and second arms 30 and 32 with the arms 30 and 32 each having a common proximal end 34 permanently joined to one another, generally as shown in FIG. 1. Each arm 30 and 32 further has a distal end, respectively 36 and 38, which has an angular displacement A preferably on the order of from seventy five to ninety degrees from the major portion or length of its respective arm 30 and 32, as indicated in FIG. 4. Other angular displacements may be used as desired.

Each of the distal ends 36 and 38 of the forceps arms includes a cylindrical matrix tube engaging tip 40 extending therefrom, with the tips 40 having diameters closely fitting within the hollow matrix tubes 24 and 26 of the matrix 10. The two matrix engaging tips 40 have lengths which penetrate only partially through the lengths of the matrix tubes 24, 26 when the tips 40 are inserted therein, in order to allow the unengaged portions of the matrix tubes to flex and conform as required to the installation between the teeth of the dental patient. Each matrix-engaging tip 40 further includes an annular matrix tube-retaining ring 42 formed integrally with the tip 40. The retaining rings 42 extend circumferentially outwardly from the cylindrical tips 40, and are of a slightly larger diameter than the internal diameters of the matrix tubes 24 and 26. This results in an interference or force fit between the matrix tube retaining rings 42 and the matrix tubes 24 and 26, thus ensuring positive retention of the matrix tubes 24 and 26 (and thus the matrix 10) by the forceps 12. FIG. 5 clearly shows this tightly fitting arrangement between the matrix tube engaging tip 40 and its ring 42 of the first forceps arm distal end 36 and the corresponding internal wall 44 of the hollow first matrix tube 24, with the flexible plastic tube 24 being outwardly distended at 46 by the relatively larger diameter of the retention ring 42 therein.

The relatively tight fit of the matrix tubes 24 and 26 about the retaining rings 42 of the matrix engaging tips 40 of the forceps 12, assures that the matrix 10 will remain secured upon the forceps tips 40 until positive release is made. The dental practitioner need only push the matrix tubes over 24 and 26 over the respective retaining rings 42 extending from the ends 36 and 38 of the forceps 12 and use the forceps 12 to maneuver the matrix 10 into place, generally as shown in FIGS. 1 and 2 of the drawings. The relatively small diameters of the two forceps arms 30 and 32 provide greatly improved comfort for the patient as the matrix 10 is held in position by the forceps 12, in comparison to the conventional means of holding a matrix in position using the fingers of the dental practitioner. When the dental filling material has cured or set, the dental practitioner need only lift the matrix 10 from its position between the teeth by using the forceps 12, which have remained engaged with the matrix 10 during the curing period. The dental practitioner may easily remove the used matrix 10 for discarding by pulling it from its engagement with the forceps tips 40 and their matrix tube retaining rings 42. The flexible nature of the nylon or other plastic material used to form the matrix tubes 24 and 26 assures that the matrix 10 will remain in place upon the forceps tips 40, yet provides for the used matrix 10 to be removed when desired with minimal effort.

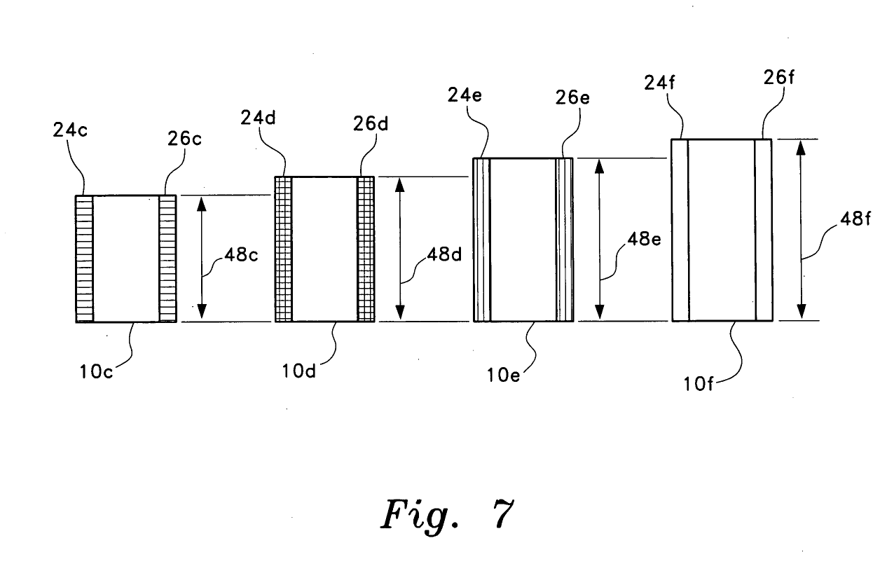

In some circumstances, the dental practitioner may desire or require matrices having different heights or dimensions from one another. Smaller matrices will be useful in working with small children, while larger matrices may be required for certain adults. Accordingly, the present invention provides a series of matrices 10c through 10f, shown in FIG. 7, each having a different height from one another. The matrix tubes, e.g., tubes 24c through 26f of the matrices 10c through 10f of FIG. 7, are preferably colored, tinted, or otherwise designated to indicate the heights of the different matrices 10c through 10f. In the example of FIG. 7, the leftmost matrix 10c has tubes 24c and 26c which are shaded blue, in order to indicate a matrix height 48c of seven millimeters. (It will be seen that the matrices 10c through 10f of FIG. 7 are drawn to an enlarged scale.) The next matrix 10d is provided with tubes 24d and 26d having a yellow color or tint, to designate its eight millimeter height 48d. The third matrix 10e of FIG. 7 has a height 48e of nine millimeters, with its matrix tubes 24e and 26e being colored red. Finally, the rightmost matrix 10f has tubes 24f and 26f which are white or uncolored, in order to designate a ten millimeter or higher matrix height 48f. Other colors or tints may be applied to one or both tubes of each of the matrices, or other means of designating the different matrix heights and/or other matrix heights than those described specifically above, may be provided in accordance with the present invention.

Preferably, all of the matrices of the present invention are transparent or at least translucent to at least ultraviolet light across the spans of their sheets or membranes. This provides for the use of conventional dental filling material which cures or sets by exposure to ultraviolet light, and the use of an ultraviolet source radiating through the ultraviolet transparent matrix sheets of the present invention. However, the matrix sheets themselves may be color-coded or otherwise formed to be translucent, so long as they are essentially transparent to the ultraviolet light used to set or cure the filling material conventionally used for such dental work.

In conclusion, the present anterior composite matrix dental restoration system greatly facilitates the control of dental filling material as it sets within the tooth of a dental patient. The dentist or practitioner need only insert the two tips of the specially configured forceps within the corresponding tubes of an appropriately dimensioned matrix, and install the matrix between the teeth adjacent the previously prepared cavity to be filled. The matrix tubes are positioned away from the tooth being filled, in order to provide a greater wrap surface for the matrix sheet about the tooth. The dental practitioner need only hold the matrix in place by means of the specially configured forceps while the filling material sets or cures, and then remove the matrix by means of the forceps once the filling has set. The present system greatly increases the comfort of both the patient and dentist or practitioner, by allowing the dentist to keep his or her fingers clear of the patient's mouth during the filling cure time. This allows the patient to relax his or her jaws to a greater degree, for greater comfort during the procedure. The present dental restoration matrix and system will thus be greatly appreciated by both dental practitioners and patients alike.

It is to be understood that the present invention is not limited to the embodiments described above, but encompasses any and all embodiments within the scope of the following claims.

I claim:

1. An anterior composite matrix dental restoration system, comprising:
(a) a dental matrix having:
(i) a thin, flexible, translucent matrix sheet of plastic material having a first end, a second end opposite the first end, a first edge, and a second edge opposite the first edge;
(ii) a first matrix tube of hollow, flexible plastic material attached to the first end of said matrix sheet;
(iii) a second matrix tube of hollow, flexible plastic material attached to the second end of said matrix sheet substantially parallel to said first matrix tube; and
(b) a dental matrix manipulation forceps tool having:
(i) a first arm and a second arm pivotally attached to the first arm, each of the arms having an angularly displaced distal end; and
(ii) first and second matrix tube-engaging tips extending from the distal end of the first and second arms, respectively, removably engaging said matrix tubes.

2. The anterior composite matrix dental restoration system according to claim 1, wherein:
each said matrix tube has a flattened matrix sheet attachment surface; and
said matrix sheet attachment surface is adhesively bonded to said matrix sheet.

3. The anterior composite matrix dental restoration system according to claim 1, wherein:
each said matrix tube has a flattened matrix sheet attachment surface; and
said matrix sheet attachment surface is fused to said matrix sheet.

4. The anterior composite matrix dental restoration system according to claim 1, wherein:
the first edge and second edge of said matrix sheet define a matrix height therebetween; and
at least one of the first and the second matrix tubes of said matrix sheet is color-coded corresponding to the respective matrix height thereof.

5. The anterior composite matrix dental restoration system according to claim 1, wherein said matrix sheet is substantially transparent to ultraviolet light.

6. The anterior composite matrix dental restoration system according to claim 1, wherein said matrix sheet is made from a material selected from the group consisting of polyester and polyethylene plastic.

7. The anterior composite matrix dental restoration system according to claim 1, wherein each said matrix tube is formed of nylon.

8. The anterior composite matrix dental restoration system according to claim 1, wherein:
the matrix tube engaging tip of the distal end of each said arm of said forceps tool is cylindrical; and
each matrix tube engaging tip further includes an annular matrix tube retaining ring formed integrally therewith forming an interference fit within a corresponding said matrix tube when engaged with said dental matrix.

9. The anterior composite matrix dental restoration system according to claim 1, wherein each of the distal ends is angularly displaced between seventy-five and ninety degrees from the corresponding arm of said forceps.

10. A dental matrix for anterior composite dental restoration, comprising:
a thin, flexible, translucent, sheet of plastic material having a first end, a second end opposite the first end, a first edge, and a second edge opposite the first edge;
a first matrix tube of hollow, flexible plastic material attached to the first end of said plastic sheet; and
a second matrix tube of hollow, flexible plastic material attached to the second end of said plastic sheet substantially parallel to said first matrix tube.

11. The dental matrix according to claim 10, wherein each said matrix tube is adhesively bonded to said matrix sheet.

12. The dental matrix according to claim 10, wherein each said matrix tube is fused to said matrix sheet.

13. The dental matrix according to claim 10, wherein:
the first edge and second edge of said matrix sheet define a matrix height therebetween; and
at least one of the first and the second matrix tubes of said matrix sheet is color-coded corresponding to the respective matrix height thereof.

14. The dental matrix according to claim 10, wherein said matrix sheet is substantially transparent to ultraviolet light.

15. The dental matrix according to claim 10, wherein said matrix sheet is made from a material selected from the group consisting of polyester and polyethylene plastics.

16. The dental matrix according to claim 10, wherein each said matrix tube is formed of nylon.

17. A forceps tool for holding a dental matrix having opposed matrix tubes at each end thereof, the tool comprising:
a first arm and a second arm pivotally attached to the first arm, each of the arms having an angularly displaced distal end;
a cylindrical matrix tube-engaging tip extending from the distal ends of each of the arms; and
an annular matrix tube-retaining ring formed integrally with each of the tips forming an interference fit within a corresponding matrix tube when engaged with the dental matrix.

18. The forceps tool according to claim 17, wherein each of the distal ends is angularly displaced between seventy-five and ninety degrees from the corresponding arm of the forceps.
